(19) United States
(12) Patent Application Publication
(10) Pub. No.: US 2005/0128939 A1
(43) Pub. Date: Jun. 16, 2005

(54) Method of performing protected transmission over a wavelengh-division multiplexed network

(76) Inventors: Stephane Lovisa, Paris (FR); Francesco Schiavoni, Antony (FR); Guy Balland, Ste Genevieve Des Bois (FR); Emmanuel Rossi, Paris (FR)

Correspondence Address: SUGHRUE MION, PLLC, 2100 PENNSYLVANIA AVENUE, N.W., SUITE 800, WASHINGTON, DC, 20037, US

(21) Appl. No.: 10/513,405

(22) PCT Filed: Apr. 29, 2003
(86) PCT No.: PCT/FR03/01338

(30) Foreign Application Priority Data
May 6, 2002 (EP) 022911358

(51) Int. Cl. H04L 12/26

(52) U.S. Cl. 370/216

(57) ABSTRACT

The invention relates to a method of providing protected transmission between two nodes (1, 2) of a wavelength-division multiplexed network. The invention proposes to have loss of signal over the main line (3) detected by a node, and then to interrupt transmission of data over the main line by said node. By interrupting transmission, it is thus possible to force loss of signal on the other node: the other node then switches its transmission of protected data over to the backup line (4). Interrupting the transmission of data can be achieved by switching off the laser of said node. The invention also describes a method of testing with a view to re-using the main line (3). The invention provides means for switching the protected data over to the backup path that are particularly simple in terms of protocol.

The invention relates to methods of providing protection between the nodes of optical communications networks, and in particular to methods of providing protection that are applied to networks having Storage Networking Certification Program (SNCP) protection, i.e. duplication of cabling.

It is known that data transmitted between two nodes of an optical communications network can be protected by duplicating the cabling between said nodes. The cabling then comprises cabling serving as a main line and cabling serving as a backup line. Data is transmitted by a node over the default main line. The receiver node sends an acknowledgement of receipt when it correctly receives the transmitted data. When a failure occurs on the main line, the receiver node does not send an acknowledgment of receipt. The transmitter node then detects a failure on the main line, and transmits a request to switch over to the backup line. The nodes then switch over to the backup line to communicate the data. That method suffers from drawbacks. It does not make it possible to make full use of the hardware capacity of the network because the backup line is not used in the absence of failure. Passband is thus lost.

International Telecommunications Union—Telecommunication Standardization Sector (ITU-T) Recommendation G. 841 proposes to use a protocol referred to as the Multiplex Switching Protection (MSP) Protocol. That protocol applies to Synchronous Digital Hierarchy (SDH) frames only. That recommendation proposes to include switching information in bytes K1/K2 of an SDH frame. Application of that recommendation to protecting traffic between two nodes is as follows: the main line is used for transmitting protected data in the absence of failure on said main line. The backup line is used to transmit additional data, also in the absence of failure of said main line. When a main line failure occurs, a first node detects that failure. Said first node interrupts transmission of the additional traffic over the backup line, and transmits the protected traffic over the backup line. The header in the SDH frames transmitted by the first node contains a request to switch over to the backup line. When the second node receives said request, it switches its transmission of protected traffic over to the backup line.

That method suffers from several drawbacks. Firstly, it requires the nodes to act on the received SDH frames in order to interpret or to modify the contents of the header. Therefore, it is not possible to use a node that is transparent to the frames. In particular, it is not possible to use transponders such as those sold by Alcatel under reference Metro Span 1696, which are designed to transmit the frames without modifying them. In addition, numerous protocols such as Escon, Gigabit Ethernet (GE), or Fiber Distributed Data Interface (FDDI) do not have header bytes suitable for containing a line switch-over request.

Recommendation G. 709 proposes a method of encapsulating protected data in a new frame including Optical channel Data Unit (ODU) and Optical channel Transport Unit (OTU) headers and Forward Error Correction (FEC). Discussion forum G. 798 proposes a method of providing protection referred to as “OTU-Trail Protection”, based on the use of the encapsulation defined in G. 709. In that method, the headers of the new frame include Automatic Protection Switching (APS) bytes containing switch-over requests. That method makes it possible to transmit switch-over requests in frames of different types.

That protection method suffers from drawbacks. Firstly, that method requires APS bytes to be read from or written into the header. Secondly, that method cannot be used with transponders that are incapable of acting on the headers.

It is also possible to imagine transmitting switching information over the Optical Supervision Channel (OSC) interconnecting various nodes. The protocols used for communicating over the OSC do not include enough bytes per frame to make it possible to transfer all of the information relating to the various wavelengths transmitted between the nodes. The OSC is thus insufficient for transmitting communications information for a large number of channels with current protocols. Developing a possible switching management protocol suitable for the OSC would require considerable investment of time and of money.

A need thus exists for a method of protecting transmission that solves one or more of those drawbacks.

The invention therefore provides a method of protecting transmission between two nodes of an optical network that are interconnected via a main both-way line and via a backup both-way line, said method comprising the following steps:
transmitting protected data over the main line;
transmitting additional data over the backup line; and
after loss of signal on reception has been detected by a node, interrupting transmission of data over the main line by said node, and having the protected data transmitted over the backup line by said node;

said method being characterized in that after the step of interrupting transmission of data over the main line by said node and of transmitting over the backup line, the method further comprises the following steps:
having a test signal sent spontaneously over the main line by said node; and
when said node receives a test signal over the main line, having it send an acknowledgement of receipt signal over the main line.

In a variant, loss of signal is detected by detecting loss of clock.

In yet another variant, interrupting transmission over the main line comprises switching off the laser of said node that is transmitting over the main line.

In still another variant, when it receives an acknowledgement of receipt signal, the node interrupts transmission of the protected data over the backup line, and the node transmits the protected data over the main line.

It is also possible to provide that the method further comprises the following steps: having a confirmation signal sent over the main line by a node when it has received an acknowledgement of receipt; and interrupting transmission of the protected data over the backup line by said node, and having the protected data transmitted over the main line by said node.

In a variant, the test, acknowledgement of receipt, and optionally confirmation signals are pulses which can be distinguished by their pulse durations.

Other characteristics and advantages of the invention will appear on reading the following description of embodiments of the invention, given by way of example and with reference to the accompanying drawings, in which:

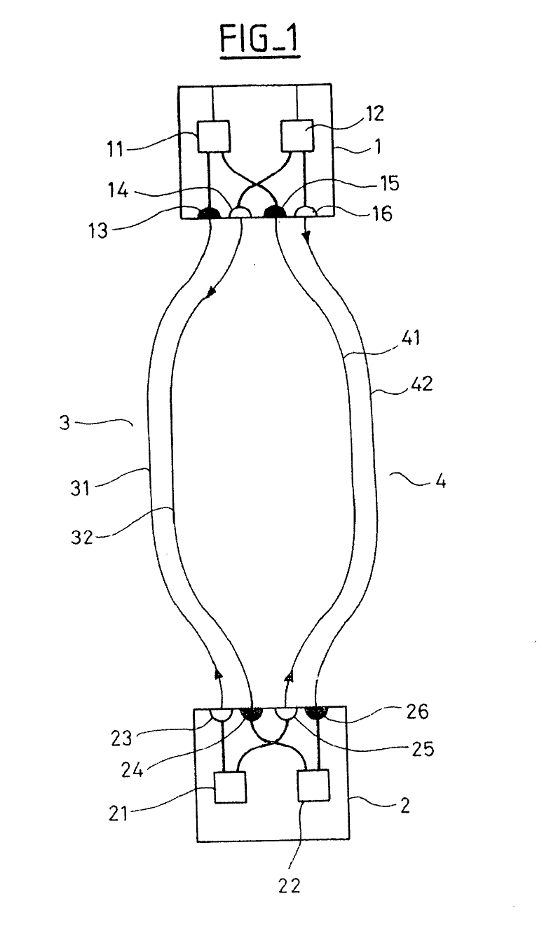

FIG. 1 diagrammatically shows a part of an optical network implementing the invention;

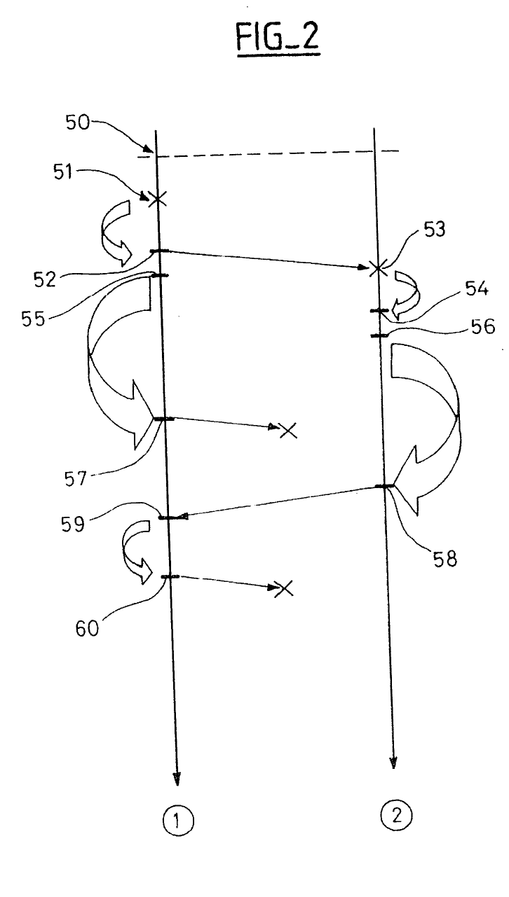

FIG. 2 shows an example of a timing diagram of the events at the nodes of FIG. 1 when the protected data is switched over to the backup line; and

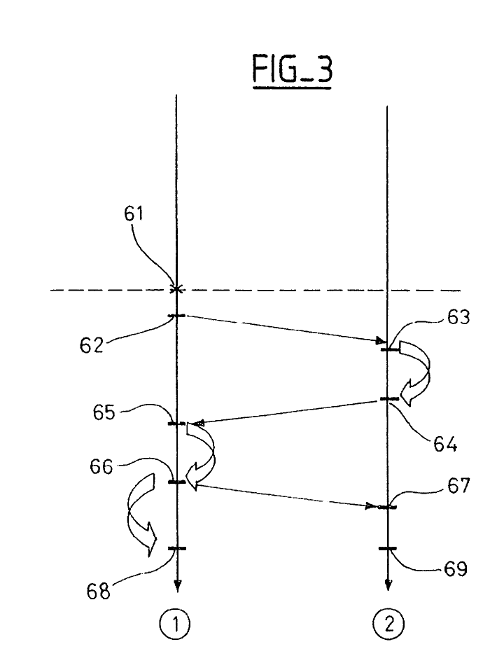

FIG. 3 shows an example of a timing diagram of the events at the nodes for resuming transmission over the main line.

The invention thus proposes to have loss of signal over the main line detected by a node, and then to interrupt transmission by said node over the main line. Interrupting transmission thus makes it possible to force loss of signal at the other node: the other node then switches its transmission of protected data over to the backup line.

FIG. 1 shows a part of an optical fiber transmission network. The part has nodes 1 and 2 interconnected firstly via a main both-way link 3 and secondly by a backup both-way link 4. FIG. 1 shows only that portion of the optical network which interconnects the nodes 1 and 2. Each node 1 or 2 has a transmitter laser diode 14, 23 connected to the main line 3, and a transmitter laser diode 16, 25 connected to the backup line 4. Each node 1 or 2 also has a receiver 13, 24 connected to the main line 3, and a receiver 15, 26 connected to the backup line 4. The optical elements 13 to 16 are connected to respective ones of the optical elements 23 to 26 via optical fibers 31, 32, 41, and 42 forming the main line and the backup line. The nodes 1 and 2 respectively have control units 12 and 21 controlling emission from the laser diodes 14 & 16 and 23 & 25 by any suitable means. The nodes 1 and 2 also respectively have processing modules 11 and 22 for processing the data coming from the receivers 13 & 15 and 24 & 26 by any suitable means.

A description is given below with reference to FIG. 2 of operation of a method of the invention. The left timing diagram shows the events at the node 1 and the right timing diagram shows the events at the node 2. Before instant 50, the nodes 1 and 2 interchange protected data over the main link 3 and additional data over the backup line. At instant 50, communication is interrupted over the main line at least in the direction going from the node 2 to the node 1. This interruption is due, for example, to an accidental break of the fiber 31. At instant 51, the node 1 detects a loss of signal over the main line. More precisely, the node 1 does not receive any signal at its receiver 13, and it thus detects a loss of clock in the processing module 11. Conventionally, an optronics component of a node oscillates at the nominal frequency of the received signal and thus recovers the clock from the signal. In the absence of a received signal, a node thus detects a loss of clock. Detection of loss of clock is preferably used because it is not sensitive to noise on the line. The oscillator cannot recover a clock from noise replacing the signal. Conversely, mere detection of absence of signal on the line can be erroneous due to amplification of the noise at the inlet of the node. At instant 52, the node 1 interrupts the data transmission over the main line. Thus, even if the fiber 32 is still usable for transmission from the node 1 to the node 2, that transmission is deliberately interrupted so that the node 2 is nevertheless informed of a problem on the line 3. Then, at instant 53, the node 2 detects a loss of signal on the main line, in a manner similar to the way in which the node 1 detects such a loss. Operation of the node 2 is then similar to operation of the node 1: at instant 54, the node 2 interrupts transmission over the main line. When a node detects a transmission problem on the line, it must inform the other node of the problem. The other node can then interrupt transmission over the line in order to comply with the applicable safety standards.

For example, transmission over the main line can be interrupted by switching off the laser of the node transmitting over said line. Similarly, it is also possible to envisage interrupting transmission by switching on the laser of the node continuously. It is possible to make provision to switch off the laser for a predetermined time suitable for being detected by the other node.

After respectively detecting loss of signal, the nodes 1 and 2 then start to transmit the protected data over the backup line, respectively at instants 55 and 56. In addition, it is possible to make provision to perform time-division multiplexing on the backup line in order to transmit protected data and additional data over said line when the data rate of protected data is sufficiently low. Such time-division multiplexing then makes it possible not to lose all of the additional traffic. Generally, transmission of additional data over the backup line 4 is previously interrupted in order to facilitate protected data transmission over said line.

Protection means for protecting data by switching over to the backup line are thus obtained that are particularly simple and reliable. Said protection means require almost no hardware modification of the nodes and can, for example, be implemented by reprogramming an electrically programmable read only memory (EPROM) of a node. The use of transmission interruption to inform the other node of a problem on the main line is also particularly fast because of the simplicity of the mode of information. In addition, use is not made of a particular enciphered communications protocol for switching over to the backup line, which makes it possible both to use transponders that are transparent to the data carried, and also not to need an encapsulation protocol to be defined. In addition, this method is equally applicable when the communication interruption affects one direction or both directions of the main line 3.

A variant of the invention also proves a method of testing and of re-using the main line. FIG. 2 also shows the test stage in which the main line is tested by the nodes 1 and 2, when transmission over said line has a problem. In this variant, the nodes transmit test signals spontaneously, and preferably at regular intervals, over the main line 3. Thus, at instant 57, the node 1 transmits a test signal spontaneously over the fiber 32 of the line 1. In the above-mentioned scenario, only the fiber 32 is interrupted and the test signal thus does not reach the node 2. The node 2 then merely transmits test signals spontaneously at regular intervals. In the preceding scenario, the fiber 31 is operational. The node 1 thus receives the test signal at the receiver 13 at instant 59. In response, the control unit 12 has an acknowledgement of receipt signal transmitted by the transmitter 14 at instant 60. This signal then does not reach the node 2, as shown in FIG. 2.

FIG. 3 is a timing diagram of testing and resuming communication over the main line, once the communication problems over the main line have been solved. At instant 61, the communication problems on the line 3 are solved. Using the above-described method, the node 1 spontaneously transmits a test signal over the line 3 at instant 62. At instant 63, the test signal is received and processed by the node 2. The control unit 21 then has an acknowledgement of receipt signal transmitted by the transmitter 23 at instant 64. The acknowledgement of receipt signal is received at instant 65 by the node 1. The node 1 then determines that communication is re-established in both directions over the link 3. It is possible to make provision for the node 1 to transmit a confirmation signal over the line 3 at instant 66 in order to inform the node 2 that the line is re-established in both directions. It is possible to provide a confirmation signal that is different from the acknowledgement of receipt signal. Thus, when an acknowledgement of receipt or a confirmation is received, a node can determine whether or not it should send a confirmation. In the example, the confirmation is received at instant 67 by the node 2.

The nodes 1 and 2 then resume transmission of the protected data over the main line 3. Transmission of additional data over the backup line 4 can then optionally resume.

The test method described thus makes it possible to resume communication over the main line 3 without action from an operator being necessary. Communication is resumed autonomously by the nodes. Communication over the main line can then also be resumed without transmitting resumption data over the backup line that serves to indicate such resumption.

The test, acknowledgement of receipt, and confirmation signals can be in form of pulses. The distinction between test signals, acknowledgement of receipt signals, and confirmation signals can be achieved by any suitable means. When the signals are in the form of pulses, it is possible to use a different pulse duration for each type of signal. For example, it is possible to provide acknowledgement of receipt signals that have pulse duration twice as long as the pulse duration of the test signals. It is also possible to use test, acknowledgement of receipt, and confirmation signals that take the form of clock signals which are frequency modulated or phase modulated. It is then possible to distinguish between the various signals by their modulation frequency or by their phase.

Naturally, the present invention is not limited to the embodiments described and shown, but rather numerous variants of it are accessible to the person skilled in the art. It is thus possible to envisage nodes having a structure other than the structure described above. In addition, although FIG. 1 shows two nodes connected together, the protection method can also be applied to two nodes connected together via a main line and via a backup line that are provided with other intermediate nodes.

1. A method of protecting transmission between two nodes (1, 2) of an optical network that are interconnected via a main both-way line (3) and via a backup both-way line (4), said method comprising the following steps:
transmitting protected data over the main line;
transmitting additional data over the backup line; and
after loss of signal on reception (51, 53) has been detected by a node, interrupting transmission of data (52, 54) over the main line by said node, and having the protected data transmitted over the backup line (55, 56) by said node;
said method being characterized in that after the step of interrupting transmission of data (52, 54) over the main line by said node and of transmitting over the backup line, the method further comprises the following steps:
having a test signal (57, 58, 62) sent spontaneously over the main line by said node; and
when said node receives a test signal over the main line, having it send an acknowledgement of receipt signal (60, 64) over the main line.

2. The method of claim 1, characterized in that loss of signal is detected by detecting loss of clock.

3. The method of clam 1, characterized in that interrupting transmission over the main line comprises switching off the laser of said node that is transmitting over the main line.

4. The method of claim 1, characterized in that, when it receives an acknowledgement of receipt signal, the node interrupts transmission of the protected data over the backup line, and the node transmits the protected data over the main line (68, 69).

5. The method of claim 1, characterized in that it further comprises the following steps:
having a confirmation signal (66) sent over the main line by a node when it has received an acknowledgement of receipt; and
interrupting transmission of the protected data over the backup line by said node, and having the protected data transmitted over the main line by said node (68, 69).

6. The method of claim 1, characterized in that the test, acknowledgement of receipt, and optionally confirmation signals are pulses which can be distinguished by their pulse durations.
